(19) United States
(12) Patent Application Publication
(10) Pub. No.: US 2023/0044842 A1
(43) Pub. Date: Feb. 9, 2023

(54) WORK ANALYZING DEVICE AND WORK ANALYZING METHOD

(71) Applicant: PANASONIC INTELLECTUAL PROPERTY MANAGEMENT CO., LTD., Osaka (JP)

(72) Inventor: Yuji SATO, Kanagawa (JP)

(73) Assignee: PANASONIC INTELLECTUAL PROPERTY MANAGEMENT CO., LTD., Osaka (JP)

(21) Appl. No.: 17/788,533

(22) PCT Filed: Dec. 2, 2020
(86) PCT No.: PCT/JP2020/044829

§ 371 Date: Jun. 23, 2022

(30) Foreign Application Priority Data
Dec. 27, 2019 (JP) 2019-238048

(51) Int. Cl. G06Q 10/06; G06T 7/246; G06V 20/52

(52) U.S. Cl. CPC G06Q 10/06398; G06Q 10/06395; G06T 7/251; G06V 20/52; G06T 2207/30196

(57) ABSTRACT

Provided are a device and a method which enable easy analysis and evaluation of work efficiency of a worker without burdensome tasks and easy determination of a worker's skill level by comparing the worker's work efficiency status with that of another worker or a past record of the same worker, wherein analytical information is produced by estimating the worker's joint positions based on a video; acquiring time series data on joint positions; determining work efficiency based on the time series data; acquiring a target range (part of a work process with low work efficiency); output an image of the target range overlaid on a graph of the time series data; and output a posture image of the worker overlaid on the video. The analytical information may include information on a working activity to be analyzed and information on a chosen model working activity with high work efficiency.

### TECHNICAL FIELD

The present disclosure relates to a work analyzing device and a work analyzing method in which a processor is caused to perform operations to output analytical information on a work efficiency status of a worker based on a video of working activities of the worker.

### BACKGROUND ART

In factories, work efficiency can be improved by analyzing work efficiency statuses of workers and changing operating procedures or other aspects of work based on results of the analysis. For this reason, there is a need for technologies for analyzing work efficiency statuses of workers in an efficient manner.

Known such technologies for analyzing work efficiency statuses of workers include a method which involves: acquiring motion information with a measuring device, the motion information quantitatively representing the motion of a worker (such as coordinate values of joints); comparing the motion information with reference motion information which represents a reference motion (standard motion) to thereby detect a motion different from the reference motion (non-standard motion); capturing images of the working worker with a shooting device; and extracting, from the captured images, an image of the worker when the worker makes a non-standard motion (Patent Document 1).

### PRIOR ART DOCUMENT (S)

### Patent Document(s)

Patent Document 1: JP2019-125023A

### SUMMARY OF THE INVENTION

### Task to be Accomplished by the Invention

The above-described prior art technology can display an image of a worker when the worker makes a non-standard motion without a heavy data processing burden on a system. However, the technology requires a lot of burdensome tasks to be performed for work efficiency analysis, such as installing a measuring device for acquiring motion information, and setting reference motion information and image extraction criteria.

In addition, there is a need that users such as a worker themselves and an administrator can easily recognize a skill level (work efficiency) of a worker or acquire other analytic information based on video data and other data of the working worker, by comparing the worker's work efficiency status with that of another worker or a past record of the same worker.

However, the prior art technologies fail to meet such a need.

The present disclosure has been made in view of the problem of the prior art, and a primary object of the present disclosure is to provide a work analyzing device and a work analyzing method which enable easy analysis and evaluation of work efficiency of a worker without burdensome tasks and easy determination of a worker's skill level by comparing the worker's work efficiency with that of another worker or a past record of the same worker.

### Means to Accomplish the Task

An aspect of the present disclosure provides a work analyzing device in which a processor is caused to perform operations to output analytical information on a work efficiency status of a worker based on a video of working activities of the worker, wherein the processor is configured to: perform a joint position estimation based on the video to estimate joint positions of the worker; acquire time series data on multiple joint positions based on results of the joint position estimation; perform a work efficiency determination based on the time series data to determine work efficiency; and generate, based on results of the work efficiency determination, the analytical information including information on a target range which is a part of a work process and the video.

Another aspect of the present disclosure provides a work analyzing method for causing a processor to perform operations to output analytical information on a work efficiency status of a worker based on a video of working activities of the worker, the operations comprising: performing a joint position estimation based on the video to estimate joint positions of the worker; acquiring time series data on multiple joint positions based on results of the joint position estimation; performing a work efficiency determination based on the time series data to determine work efficiency; and generating, based on results of the work efficiency determination, the analytical information including information on a target range which is a part of a work process and the video.

### Effect of the Invention

According to the present disclosure, analytical information on a target range of a work process is acquired based on a video, which enables easy analysis and evaluation of work efficiency of a worker without burdensome tasks. In addition, a user such as a worker themselves or an administrator is enabled to quickly recognize a work efficiency status in the target range.

### BRIEF DESCRIPTION OF THE DRAWINGS

FIG. 1 is a diagram showing a general configuration of a work analyzing system according to a first embodiment of the present disclosure;

FIG. 2 is an explanatory diagram showing an outline of a joint position estimation operation performed by a server 3;

FIG. 3 is an explanatory diagram showing time series graphs generated by the server 3;

FIG. 4 is an explanatory diagram showing an outline of a working activity evaluation operation performed by the server 3;

FIG. 5 is a block diagram showing a schematic configuration of the server 3;

FIG. 6 is a flow chart showing a procedure of a working activity collection operation performed by the server 3;

FIG. 7 is a flow chart showing a procedure of an analysis target designation operation performed by the server 3;

FIG. 8 is an explanatory diagram showing a search screen displayed on a user terminal 4;

FIG. 9 is an explanatory diagram showing a setting screen displayed on the user terminal 4;

FIG. 10 is an explanatory diagram showing a single subject mode analysis result screen displayed on the user terminal 4;

FIG. 11 is an explanatory diagram showing a model-record-based-comparison analysis result screen displayed on the user terminal 4; and

FIG. 12 is an explanatory diagram showing a past-record-based-comparison analysis result screen displayed on the user terminal 4;

### DESCRIPTION OF THE PREFERRED EMBODIMENT(S)

A first aspect of the present invention made to achieve the above-described object is a work analyzing device in which a processor is caused to perform operations to output analytical information on a work efficiency status of a worker based on a video of working activities of the worker, wherein the processor is configured to: perform a joint position estimation based on the video to estimate joint positions of the worker; acquire time series data on multiple joint positions based on results of the joint position estimation; perform a work efficiency determination based on the time series data to determine work efficiency; and generate, based on results of the work efficiency determination, the analytical information including information on a target range which is a part of a work process and the video.

In this configuration, analytical information on a target range of a work process is acquired based on a video, which enables easy analysis and evaluation of work efficiency of a worker without burdensome tasks. In addition, a user such as a worker themselves or an administrator is enabled to quickly recognize a work efficiency status in the target range.

A second aspect of the present invention is the work analyzing device of the first aspect, wherein the processor is configured to: output information on a section in which the work efficiency is determined to be low, as the information on the target range.

In this configuration, a user is enabled to quickly recognize a work efficiency status in a section of a work process in which work efficiency is low, and thus which is highly required to be improved.

A third aspect of the present invention is the work analyzing device of the first aspect, wherein the processor is configured to: output an image representing the target range as the analytical information, the image being overlaid on a time series graph that visualizes the time series data.

In this configuration, a user can visually check a time series graph(s) to thereby recognize a characteristic of a working activity. In particular, a user can quickly check a working activity within a target range in the time series graph.

A fourth aspect of the present invention is the work analyzing device of the first aspect, wherein the processor is configured to: output a posture image indicating a posture of the worker generated based on the joint positions as the analytical information, the posture image being overlaid on the video.

In this configuration, a posture image schematically representing a worker's posture is overlaid on a video, which enables a user to quickly recognize actual working activities of the worker.

A fifth aspect of the present invention is the work analyzing device of the first aspect, wherein the processor is configured to: as a model working activity to be compared to a target working activity that is subject to analysis, choose a working activity with high work efficiency; and output the analytical information on the target working activity and the analytical information on the model working activity.

In this configuration, a user is enabled to easily recognize a skill level of the worker performing a working activity that is subject to analysis based on comparison with another worker's work efficiency status.

A sixth aspect of the present invention the work analyzing device of the fifth aspect, wherein the processor is configured to: output thumbnail images for videos of corresponding a plurality of model working activities; and when a user selects one of the thumbnail images, output the analytical information on the model working activity corresponding to the selected thumbnail image.

In this configuration, a user is enabled to choose one model working activity from a plurality of model working activities and view analytical information on the chosen model working activity.

A seventh aspect of the present invention is the work analyzing device of the first aspect, wherein the processor is configured to: as a model working activity to be compared to a target working activity that is subject to analysis, choose a past working activity that a person performing the target working activity has performed before; and output the analytical information on the target working activity and the analytical information on the past working activity.

In this configuration, a user is enabled to easily recognize a skill level of the worker performing a target working activity that is subject to analysis based on comparison with the same worker's past record of work efficiency status.

An eighth aspect of the present invention is the work analyzing device of the eighth aspect, wherein the processor is configured to: output thumbnail images for videos of corresponding a plurality of past working activities; and when a user selects one of the thumbnail images, output the analytical information on the past working activity corresponding to the selected thumbnail image.

In this configuration, a user is enabled to choose one past working activity from a plurality of past working activities and view analytical information on the chosen past working activity.

A ninth aspect of the present invention is the work analyzing device of the first aspect, wherein the processor is configured to: output a search screen on which a user can enter one or more search criteria; and output the analytical information on a working activity which meets the entered search criteria.

In this configuration, a user is enabled to easily narrow down a target working activity that is subject to analysis.

A tenth aspect of the present invention is the work analyzing device of the first aspect, wherein the processor is configured to: output a settings screen on which a user can designate a target joint of a human body; and output the analytical information on the target joint designated by the user through the settings screen.

In this configuration, a user is enabled to easily narrow down a target joint that is subject to analysis.

An eleventh aspect of the present invention is a work analyzing method for causing a processor to perform operations to output analytical information on a work efficiency status of a worker based on a video of working activities of the worker, the operations comprising: performing a joint position estimation based on the video to estimate joint positions of the worker; acquiring time series data on multiple joint positions based on results of the joint position estimation; performing a work efficiency determination based on the time series data to determine work efficiency; and generating, based on results of the work efficiency determination, the analytical information including information on a target range which is a part of a work process and the video.

This configuration enables easy analysis and evaluation of work efficiency of a worker without burdensome tasks, in the same manner as the first aspect.

Embodiments of the present disclosure will be described below with reference to the drawings.

### First Embodiment

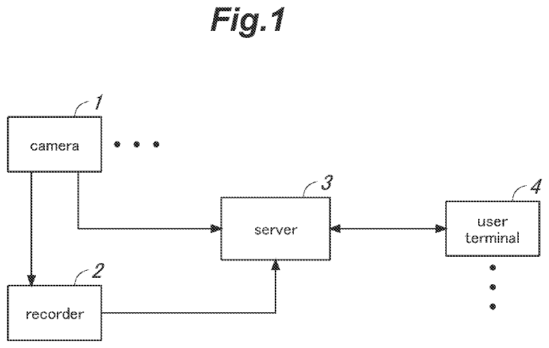

FIG. 1 is a diagram showing a general configuration of a work analyzing system according to a first embodiment of the present disclosure.

The work analysis system is configured to analyze a work efficiency status of a worker in a workplace such as a factory to thereby present results of the analysis to an administrator, and the system includes a camera 1, a recorder 2, a server 3 (work analyzing device), and a user terminal 4.

The camera 1 shoots working activities of the worker at the worker's place.

The recorder 2 records video data provided from the camera.

The server 3 acquires a video(s) from the camera 1 and/or the recorder 2, analyzes the work efficiency status of the worker based on the video, and outputs results of the analysis.

The user terminal 4 is used by a user such as a system administrator, a work administrator, or a worker themselves is implemented by a PC, a tablet terminal, or any other suitable device. A system administrator uses the user terminal 4 to configure settings for various operations performed by the server 3. In addition, the user terminal 4 displays results of analyses provided from the server 3 so that a work administrator or a worker themselves can view the results.

The server 3 may perform real-time operations while the camera is shooting a video, or post-processing operations after the camera shoots a video. When the real-time operations are performed, the camera 1, the server 3, and the user terminal 4 may be connected via a network. When only the post-processing operations are performed, video recordings accumulated in the recorder 2 may be transferred to the server 3 by using an appropriate storage medium.

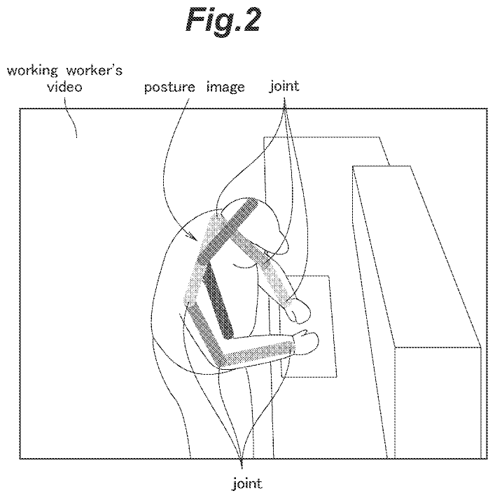

Next, a joint position estimation operation performed by the server 3 will be described. FIG. 2 is an explanatory diagram showing an outline of the joint position estimation operation performed by a server 3.

In the present embodiment, the system estimates joint positions of a person from the frame image of each time included in analysis target video data to acquire joint position data of each time (each frame image) (joint position estimation operation). Each position of a joint is represented by two-dimensional coordinates (x, y).

In an example shown in FIG. 2, a worker performs working activities on a workbench, such as a working activity of sorting parts to be used in a production line by type, and storing them in a parts case. In this case, since a worker performs the work mainly by moving the upper body, measurement target joints are eight joints of the upper body (left wrist, left elbow, left shoulder, right shoulder, head, right elbow, right wrist, abdomen).

In the present embodiment, a posture image schematically representing a person's posture is overlaid on a working worker's video. A posture image is a diagram representing a human skeleton, the diagram consisting of lines connecting positions of joints of the human skeleton (skeleton lines). Skeleton lines are classified by colors, which enables a user to quickly grasp the movement of a person.

In the present embodiment, when estimating the joint positions of a person from the frame image at each time, the system generates joint position data indicating the respective joint positions at each time as a result of the estimation. The joint position data includes a process ID, a measurement number, a person ID, time information, and joint coordinate information.

The process ID is an ID given to each process (or task). The measurement number is a serial number assigned to each of the measurement operations performed multiple times associated with one process. The person ID is an ID given to each worker. The time information is information on the measurement time (year, month, day, hour, minute, and second). Working activities are distinguished from one another by the combination of a process ID, a measurement number, and a person ID. For example, when certain activities are performed by the same person in the same process but have different measurement numbers, they are different working activities.

The joint coordinate information includes joint coordinate values (x coordinate and y coordinate) and a reliability score. The reliability score is an index indicating the reliability of joint coordinate values as a result of the joint position estimation, and the greater the score value, the higher the reliability.

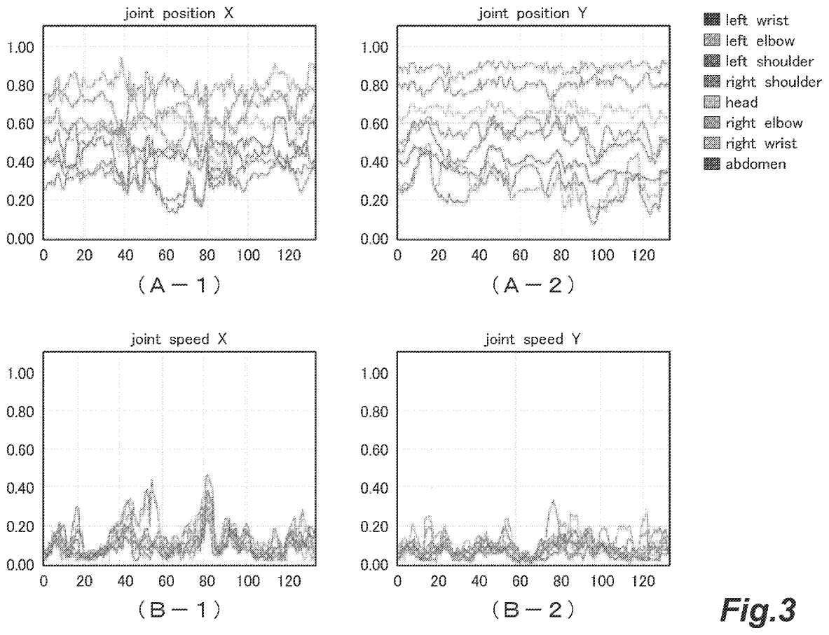

Next, time series graphs generated by the server 3 will be described. FIG. 3 is an explanatory diagram showing time series graphs generated by the server 3.

In the present embodiment, the system generates time series data including joint positions of each joint at a series of times based on joint position data for each joint at respective times (time series data generation operation). Next, the system generates time series graphs that visualize the time series data of the joint positions (time series graph generation operation). Then, the system analyzes independently the movement in the X-axis direction (horizontal direction in the image) and the movement in the Y-axis direction (vertical direction in the image). Accordingly, the system generates time series graphs of the positions of a joint in the X-axis direction (X coordinate) and the position in the Y-axis direction (Y coordinate), respectively. Specifically, the system generates a time series graph of the X coordinates of joint positions shown in FIG. 3(A-1) and a time series graph of the Y coordinates of joint positions shown in FIG. 3(A-2). In such a time series graph of joint positions, the horizontal axis represents time and the vertical axis represents X or Y coordinate values.

In the present embodiment, joint speed information (information on joint movement speed) may be selected as joint information to be analyzed in place of joint position information. When the joint speed information is selected, the system generates a time series graph of the joint speed along the X coordinate shown in FIG. 3(B-1) and a time series graph of the joint speed along the Y coordinate shown in FIG. 3(B-2). In such a time series graph of joint speed, the horizontal axis represents time, and the vertical axis represents the speed of the X coordinate or the Y coordinate. The system may acquire a joint speed from the amount of change in the joint position at each time (each frame).

In the present embodiment, a time series graph of each joint is generated as a line graph. In addition, time series graphs for the respective joints are indicated in different colors.

In the case of a skilled worker, the worker makes little wasted motions of each part of the body, and moves the parts of the body in a synchronized manner. In particular, the worker uses the left hand and right hands for the respective routine operations such that the both hand are moved in a synchronized manner. For example, in the case where an operation needs to repeat a set of tasks of acquiring parts and storing the parts, a skilled worker simultaneously acquires different types of parts with both hands, respectively, and then performs the task of storing the parts with the right hand. In other cases, a skilled worker uses the left hand to acquire parts and then uses the right hand to store the parts. In this case, a time series graph can show that, for example, both hands move to the right at the same time, which means that the worker acquires parts with both hands.

In the case of a beginner worker, the worker makes a lot of wasted motions of each part of the body, and moves the parts of the body in an unsynchronized, irregular manner. In particular, the left hand and right hands are not used for the respective routine operations and are not moved in a synchronized manner. For example, in the case where an operation needs to repeat a set of tasks of acquiring parts and storing the parts, a beginner worker tends to pick up one part with one hand. In this case, a time series graph can show that, for example, only the left hand moves to the right, which means that the worker acquires parts with one hand.

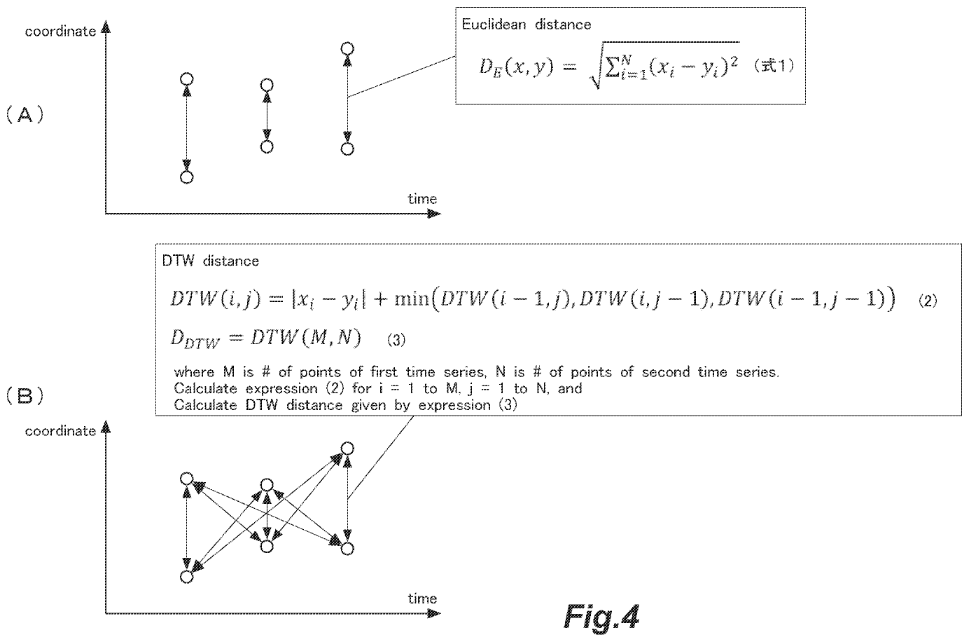

Next, a working activity evaluation operation performed by the server 3 will be described. FIG. 4 is an explanatory diagram showing an outline of the working activity evaluation operation performed by the server 3.

In the present embodiment, the system evaluates work efficiency according to whether or not the respective parts of the body are moved in a synchronized manner. Furthermore, in the present embodiment, the system calculates the similarity between sets of time series data for the respective joints, and determines, based on the calculated similarity, whether or not the respective parts of the body are moved in a synchronized manner. In other words, the system evaluates work efficiency based on the similarity between sets of time series data for the respective joints. For example, when the similarity between sets of time series data for the respective joints is high, the system determines that the work efficiency is high, and when the similarity between sets of time series data for the respective joints is low, the system determines that the work efficiency is low.

In the present embodiment, the system calculates a co-occurrence score (efficient motion score) representing the degree of similarity as an index value for evaluating work efficiency. The system compares the co-occurrence score with a predetermined threshold to thereby determine if the similarity between sets of time series data for the respective joints is high; that is, if the work efficiency is high. More specifically, when the co-occurrence score is equal to or higher than the threshold value, the system determines that the work efficiency is high.

In the present embodiment, examples of indices of similarity between two sets of time series data include a Euclidean distance and a DTW (Dynamic Time Warping) distance. In the present embodiment, the system calculates the DTW distance as an index of the similarity between two sets of time series data for the respective joints.

The Euclidean distance is a distance between two points of the same time in two sets of time series data, as shown in FIG. 4(A). With the use of this distance, when there is a significant time lag between two sets of time series data, the degree of similarity cannot be appropriately calculated.

As shown in FIG. 4(B), the DTW distance is the shortest distance among the distances calculated between each point in one set of time series data and all the points in the other set of time series data; that is, the distance acquired by comparing all the calculated distances to choose the shortest one. For example, when the number of joints is eight, the distances between a pair of points are calculated between 28 (8×7/2) combinations of points.

With the use of this method, the degree of similarity can be appropriately calculated even when some joint positions of a person are hidden by a shielding object, some part of time series data is missing, there is a time lag between two sets of time series data, or the lengths of the two sets of time series data are different.

Although, in the present embodiment, work efficiency is determined based on the similarity of sets of time series data for joints, the work efficiency may be determined by a set of time series data collected for each part of the body such as the right arm and the left arm, instead of that for each joint. For example, work efficiency can be determined based on the similarity of sets of time series data of the right arm and the left arm. In the case of a skilled worker, since the right arm and the left arm are moved in a synchronized manner, the system can determine that a worker is a skilled one when there is a high degree of similarity between the sets of time series data of the right and left arms. In this case, position data of the right arm and that of the left arm can be generated by integrating sets of position data of the joints of the right arm and those of the joints of the left arm, respectively.

Although, in the present embodiment, the system is configured to calculate, as an index value for evaluating work efficiency, a co-occurrence score (efficient motion score) representing similarity, more accurately, the degree of similarity between sets of time series data of the respective joints, the system may use an index value other than a co-occurrence score to determine work efficiency.

For example, the system may use a variance of each joint position to determine work efficiency. A greater swing width of joint position indicates that there are many wasted motions and thus a working activity is not efficient. In this case, a variance of each joint position becomes large. Thus, the system can determine work efficiency based on a variance of each joint position. In other cases, the system may use a “joint speed” (joint movement speed) to determine work efficiency.

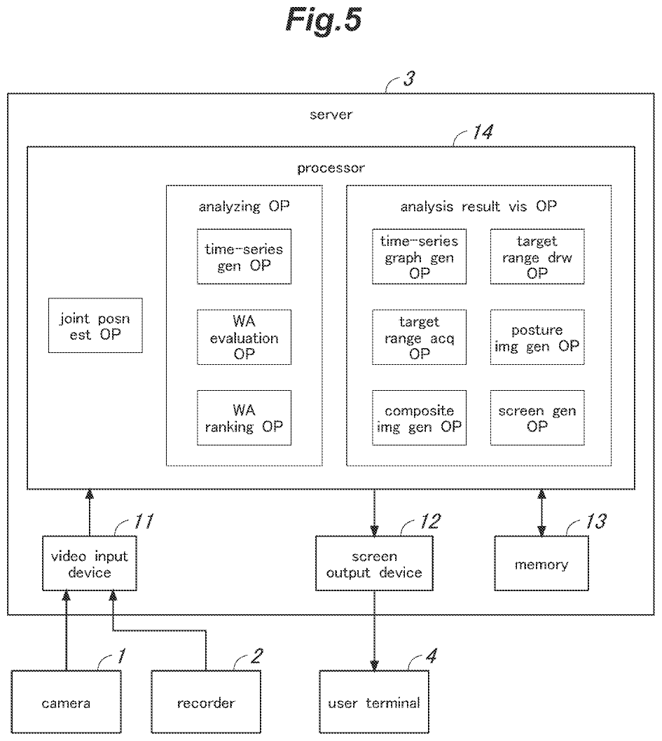

Next, a schematic configuration of the server 3 will be described. FIG. 5 is a block diagram showing a schematic configuration of the server 3.

The server 3 includes a video input device 11, a screen output device 12, a memory 13, and a processor 14.

When the server 3 performs real-time operations, the video input device 11 receives a video shot by the camera 1. When the server 3 performs post-processing operations, the video input device 11 receives a video recorded in the recorder 2.

The screen output device 12 outputs various screens generated by the processor 14, and the various screens are displayed on the user terminal 4.

The memory 13 stores programs to be executed by the processor 14. The memory 13 stores video data acquired by the video input device 11. The memory 13 stores joint position data, information on model working activity, and other information generated by the processor 14.

The processor 14 performs various processing operations associated with work analysis (working activity analysis) by executing programs stored in the memory 13. In the present embodiment, the processor 14 performs a joint position estimation operation, an analyzing operation, an analysis result visualization operation, and other operations.

In the joint position estimation operation, the processor 14 acquires a frame at each time from the video data, estimates the joint positions of a person in each frame image, and acquires coordinate information for each joint at each time. The processor 14 stores in the memory 13 the coordinate information for each joint at each time acquired in the joint position estimation operation, together with a process ID, a measurement number, a person ID, and time information, as joint position data at each time.

The analyzing operation includes a time series data generation operation, a working activity evaluation operation, and a working activity ranking operation.

In the time series data generation operation, the processor 14 generates time series data of joint positions for each joint based on the joint position data for each joint at each time acquired in the joint position estimation operation.

In the working activity evaluation operation, the processor 14 calculates a co-occurrence score (efficient motion score) representing the degree of similarity between sets of time series data for each pair of joints as an index value for evaluating work efficiency associated with a working activity. In particular, the processor 14 calculates the co-occurrence score for each set of the entire length of time series data based on the sets of time series data associated with a working activity to be evaluated. Then, each set of time series data is divided by a predetermined period of time (for example, 3 to 5 seconds) to generate divided parts of the time series data for respective unit periods, and the processor 14 calculates a co-occurrence score for each unit period. Specifically, when the unit period is set as five seconds for 60-second time series data, the processor first calculates a co-occurrence score for the first five-second period of the time series data, and next the processor calculates a co-occurrence score for a five-second period starting from one second after the beginning of the time series data. Then, the processor repeats to calculate a co-occurrence score for each of the subsequent five-second periods starting at one second intervals (e.g. five-second periods starting two seconds and three seconds after the beginning of the time series data, respectively) until calculating a co-occurrence score for the last five-second period of the 60-second time series data. The unit period may be changed to a different period of time such as 10 seconds or 30 seconds, depending on the length of time series data, in order to reduce the number of times the processor needs to calculate co-occurrence scores.

In the working activity ranking operation, the processor 14 ranks recorded working activities for the same task (working activities with the same process ID) based on the respective co-occurrence scores of the working activities. Then, the processor 14 selects a predetermined number (for example, 5) of working activities in descending order of co-occurrence scores among the ranked working activities, as model working activities (recorded working activities performed with high efficiency).

The analysis result visualization operation includes a time series graph generation operation, a target range acquisition operation, a target range drawing operation, a posture image generation operation, a posture image overlay operation, and a screen generation operation.

In the time series graph generation operation, the processor 14 generates time series graphs (see FIG. 3) that visualizes the time series data of joint positions acquired in the time series data generation operation.

In the target range acquisition operation, the processor 14 acquires a target range based on the co-occurrence scores for the respective unit periods acquired in the working activity evaluation operation. The “target range” is a part of a work process to be analyzed (i.e., within a period during which time series data is measured), in which the similarity between sets of time series data for the joints is low; that is, in which a co-occurrence score is below a predetermined threshold value.

In the target range drawing operation, the processor 14 draws rectangular labels 65, 66 (mark images) overlaid on time series graphs, each rectangular label representing a target range acquired in the target range acquisition operation.

In the posture image generation operation, the processor 14 generates a posture image at each time (each frame image) based on the joint position data at each time. A posture image is a diagram schematically representing a worker's posture and consisting of lines connecting positions of joints, the lines being classified by color.

In the posture image overlay operation, the processor 14 overlays the posture image at each time acquired in the posture image generation operation on the frame image to generate a composite image.

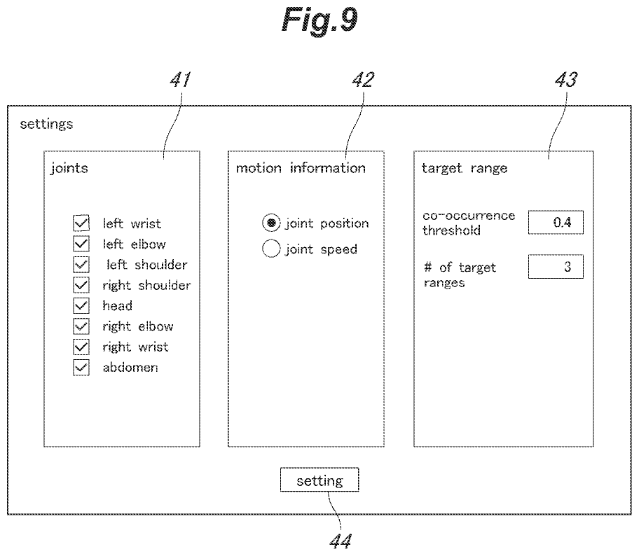

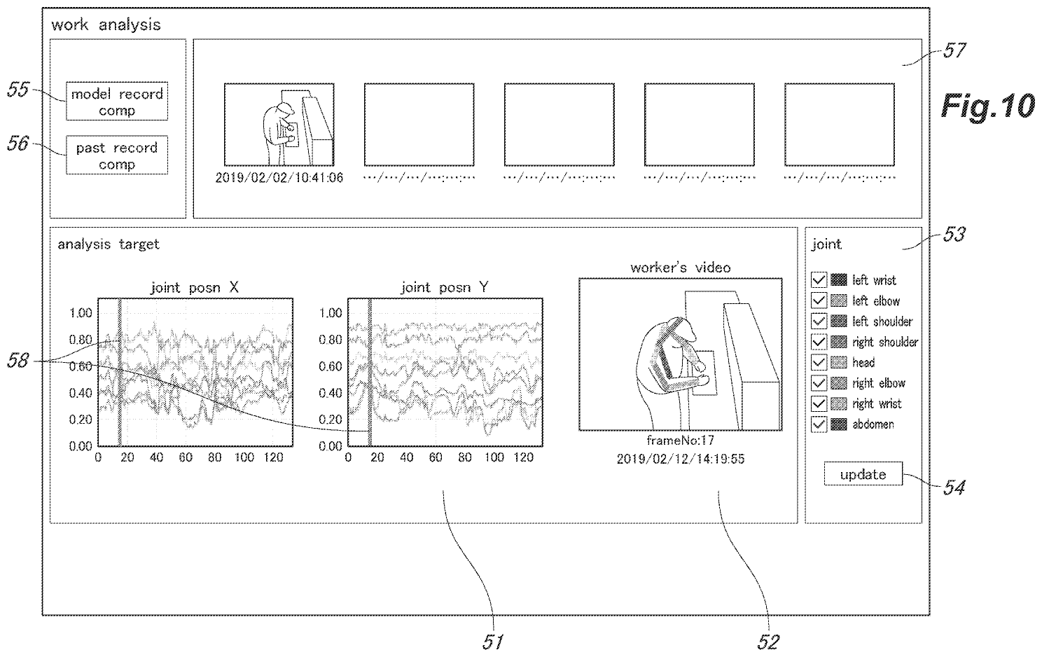

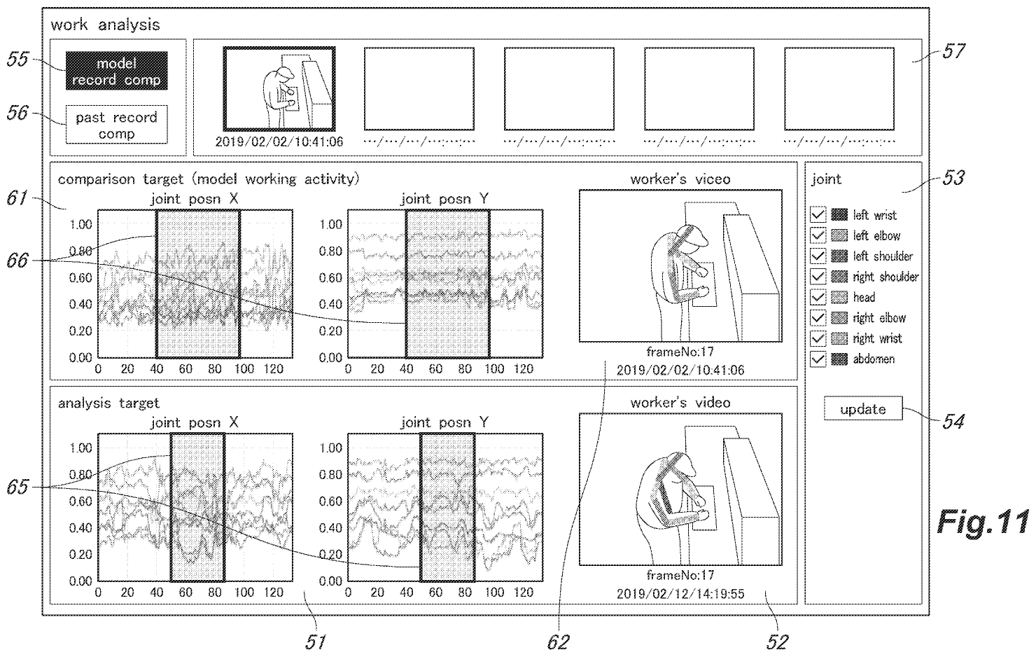

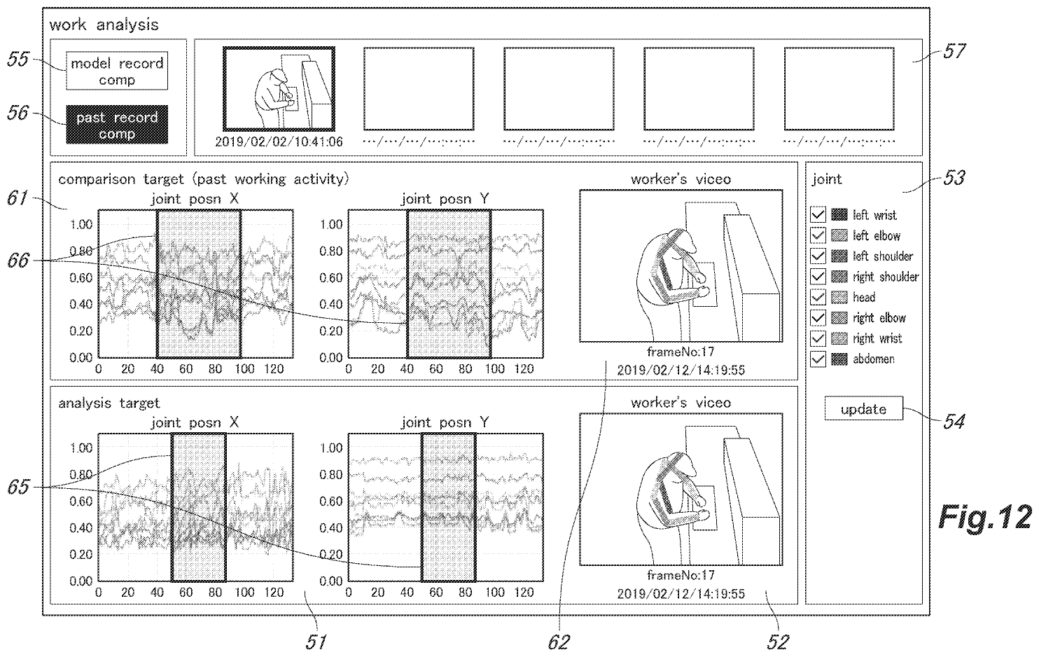

In the screen generation operation, the processor 14 generates screens to be displayed on the user terminal 4 and provides the generated screens to the user terminal 4. In the present embodiment, the processor 14 generates various screens including a setting screen (see FIG. 9), a single subject mode analysis result screen (see FIG. 10), a model-record-based-comparison analysis result screen (see FIG. 11), and a past-record-based-comparison analysis result screen (see FIG. 12).

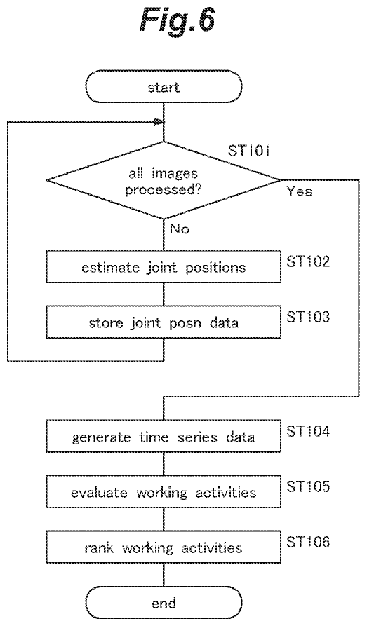

Next, a working activity collection operation performed by the server 3 will be described. FIG. 6 is a flow chart showing a procedure of the working activity collection operation performed by the server 3.

First, the processor 14 in the server 3 acquires video data of a working activity that is a candidate for a model working activity from the memory 13, and determines whether or not all the frame images including the video data have been processed (ST101).

When all the frame images have not been processed (No in ST101), the processor 14 estimates the joint positions of a worker from the target frame image (joint position estimation operation) (ST102). Next, the processor 14 generates joint position data including joint coordinate information for each joint and stores the generated data in the memory 13 (ST103).

The processor 14 repeats these operations for all the frame images included in the video data of the working activity to be analyzed. As a result, joint position data for each joint at each time (each frame image) associated with the working activity is stored and accumulated in the memory 13.

Next, the processor 14 in the server 3 generates time series data of joint positions for each joint based on the joint position data for the joint at each time (time series data generation operation) (ST104). Then, the processor 14 calculates a co-occurrence score of the working activity to be analyzed based on the time series data of joint positions for each joint (working activity evaluation operation) (ST105). Then, the processor 14 ranks the recorded working activities for the same task based on the co-occurrence score of each working activity (working activity ranking operation) (ST106).

When there are two or more sets of video data to be analyzed, the processor repeats the operation procedure shown in FIG. 6 for each set of video data.

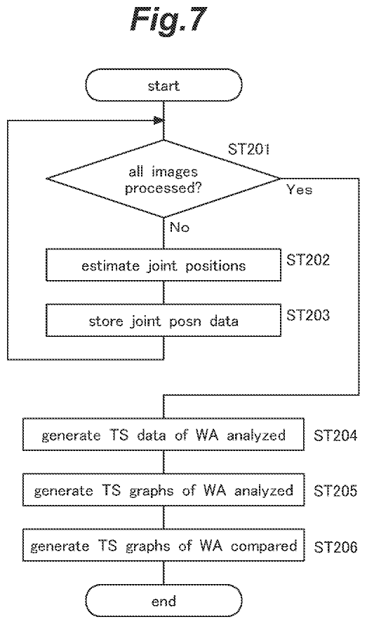

Next, a procedure of an analysis target designation operation performed by the server 3 will be described. FIG. 7 is a flow chart showing a procedure of the analysis target designation operation performed by the server 3.

First, the processor 14 in the server 3 acquires video data to be analyzed from the memory 13, and determines whether or not all the frame images including the video data have been processed (ST201).

When all the frame images have not been processed (No in ST201), the processor 14 estimates the joint positions of a worker from the target frame image (joint position estimation operation) (ST202). Next, the processor 14 generates joint position data including joint coordinate information for each joint and stores the generated data in the memory 13 (ST203).

The processor 14 repeats these operations for all the frame images included in the video data of the working activity to be analyzed. As a result, joint position data for each joint at each time (each frame image) associated with the working activity is stored and accumulated in the memory 13.

Next, the processor 14 in the server 3 generates time series data of joint positions for each joint based on the joint position data for the joint at each time (time series data generation operation) (ST204). Then, the processor 14 generates time series graphs that visualize the time series data to be analyzed (time series graph generation operation) (ST205).

Then, processor 14 acquires time series data associated with a working activity to be compared with the time series data to be analyzed from the memory 13 and generates time series graphs that visualize the acquired time series data (time series graph generation operation) (ST206). The working activity to be compared with the time series data to be analyzed is a working activity chosen by a user among recorded model working activities. A model working activity is a working activity performed with high efficiency among the recorded working activities for the same task as the working activity to be analyzed.

In addition, the processor in the server 3 also performs an operation for calculating a co-occurrence score for each unit period (working activity evaluation operation), an operation for acquiring a target range (part of a work process in which work efficiency is low) (target range acquisition operation), an operation for drawing rectangular labels 65, 66 overlaid on time series graphs, each rectangular label representing a target range (target range drawing operation), an operation for generating a posture image from joint position data (posture image generation operation), an operation for overlaying the posture image on the frame image (posture image overlay operation), and an operation for generating and outputting analysis result screens including time series graphs and videos (screen generation operation).

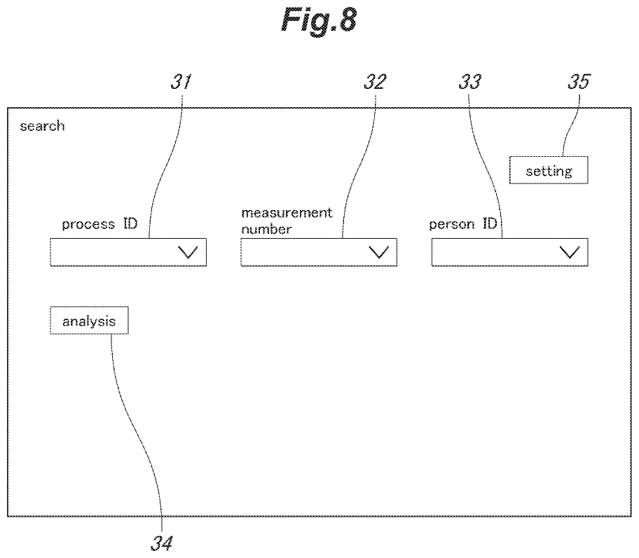

Next, a search screen displayed on the user terminal 4 will be described. FIG. 8 is an explanatory diagram showing the search screen displayed on the user terminal 4.

The user terminal 4 displays a search screen which a user can use for searching for a working activity which meets search criteria.

The search screen includes input interfaces 31, 32, 33 for a process ID, a measurement number, and a person ID, and an analysis button 34. A use can enter a process ID, a measurement number, and a person ID as search criteria using the input interfaces 31, 32, and 33. In particular, in the present embodiment, a user can select a process ID, a measurement number, and a person ID from the respective pull-down menus. Each pull-down menu indicates options filtered based on conditions selected in other input interfaces.

When a user enters each a process ID, a measurement number, and a person ID as the search criteria using the input interfaces 31, 32, 33 and operates the analysis button 34, the systems searches for a working activity which meets the entered search criteria, and then causes the screen to transition to a single subject mode analysis result screen (see FIG. 10) associated with the found working activity.

The search screen also includes a setting button 35. When a user operates the setting button 35, the screen transitions to a setting screen (see FIG. 9).

Next, a setting screen displayed on the user terminal 4 will be described. FIG. 9 is an explanatory diagram showing the setting screen displayed on the user terminal 4.

The user terminal 4 displays a setting screen which a user uses for configuring the settings for various processing operations associated with work analysis. The setting screen is displayed when a user operates the setting button 35 on the search screen (see FIG. 8).

The setting screen includes a joint designation interface 41. A user can designate joints to be analyzed by using the check boxes for the respective joints in the joint designation interface 41. In the embodiments shown in FIG. 9, a user can designate any combination of the eight joints of the upper body (left wrist, left elbow, left shoulder, right shoulder, head, right elbow, right wrist, and abdomen). For example, when designating only the joint of the right arm and narrows down the analysis target thereto, a user can recognize only the motion of the right arm.

This setting screen also includes a motion information designation interface 42. A user can designate either the joint position or the joint speed as the type of motion information to be analyzed by using a radio button in the motion information designation interface 42. When a user chooses the joint position, the system performs operations associated with work analysis (such as time series data generation operation, working activity evaluation operation, and time series graph generation operation) based on joint positions as motion information. When a user chooses the joint speed, the system uses joint movement speeds as motion information to perform operations associated with work analysis.

This setting screen also includes a target range designation interface 43. A user can operate the target range designation interface 43 to enter a threshold value for co-occurrence scores that is used to set a target range, and an upper limit value for restricting the number of target ranges.

This setting screen also includes a setting button 44. A user can operate the setting button 44 to configure the settings based on setting information which the user has entered using the joint designation interface 41, the motion information designation interface 42, and the target range designation interface 43.

Next, a single subject mode analysis result screen displayed on the user terminal 4 will be described. FIG. 10 is an explanatory diagram showing the single subject mode analysis result screen displayed on the user terminal 4.

The user terminal 4 displays a single subject mode analysis result screen for presenting to a user an analysis result associated with a working activity which meets search criteria designated by a user (such as administrator). The single subject mode analysis result screen is displayed when the user enters a process ID, a measurement number, and a person ID using the input interfaces 31, 32, 33 on the search screen (see FIG. 8) and then operates the analysis button 34.

This single subject mode analysis result screen includes a time series graph indicator 51. The time series graph indicator 51 indicates two time series graphs of joint positions associated with the working activity to be analyzed. One graph is a time series graph of the X coordinates of joint positions, while the other graph is a time series graph of the Y coordinates of joint positions.

This single subject mode analysis result screen includes a working worker's video indicator 52. The working worker's video indicator 52 displays a working worker's video associated with the working activity to be analyzed. The working worker's video indicator 52 also indicates a posture image showing a posture of the worker overlaid on the working worker's video. The working worker's video indicator 52 indicates a shooting time and a frame number of the working worker's video. The frame number is a serial number assigned to each frame included in the working worker's video, where a frame number of 0 is assigned to the first frame.

The working worker's video indicator 52 initially displays the first frame image of a working worker's video data as a still image When a user operates (clicks) to designate a position on the time series graph, the working worker's video indicator 52 starts reproducing the working worker's video from the designated position (time). While reproducing the video, the working worker's video indicator 52 also indicates an image 58 showing a current reproduction position of the working worker's video overlaid on each time series graph.

This single subject mode analysis result screen also includes a joint designation interface 53. The joint designation interface 53 includes check boxes for the respective joints in the same manner as the setting screen (see FIG. 9). A user can use the check boxes to re-designate joints to be analyzed; that is, changing the initial settings configured by using the setting screen.

This joint designation interface 53 includes an update button 54. When a user changes the initial settings and operates the update button 54, the new settings are reflected and the system performs the time series graph generation operation so that the time series graphs indicated in the time series graph indicator 51 is updated to new ones associated with the joints designed by the user.

This single subject mode analysis result screen includes a “model record comparison” button 55, a “past record comparison” button 56, and a thumbnail indicator 57. The thumbnail indicator 57 indicates a predetermined number of thumbnail images of the working worker's videos (five images in FIG. 10).

When a user operates the “model record comparison” button 55, the thumbnail indicator 57 indicates a plurality of thumbnail images of the working worker's videos of model working activities; that is, working activities which are for the same task as the working activity to be analyzed (working activities with the same process ID), and are ranked higher in terms of co-occurrence score. These thumbnail images are indicated side by side in descending order of co-occurrence scores from the left. When a user operates the thumbnail indicator to select one of the thumbnail images, the screen transitions to a model-record-based-comparison analysis result screen (see FIG. 11).

When a user operates the “past record comparison” button 56, the thumbnail indicator 57 indicates a plurality of thumbnail images of the working worker's videos of past working activities; that is, past working activities for the same task and performed by the same person as the working activity to be analyzed. These thumbnail images are associated with working activities performed at a predetermine time (e.g., one day, one week, or one month) before the time when the working activity to be analyzed was measured. When a user operates the thumbnail indicator to select one of the thumbnail images, the screen transitions to a past-record-based-comparison analysis result screen (see FIG. 12).

When a user operates the joint designation interface 53 to re-designate joints to be analyzed, the system performs the working activity evaluation operation and the working activity ranking operation, and in the case that the rank of the working activities changes, the system updates a set of thumbnail images indicated in the thumbnail indicator 57.

Next, a model-record-based-comparison analysis result screen displayed on the user terminal 4 will be described. FIG. 11 is an explanatory diagram showing the model-record-based-comparison analysis result screen displayed on the user terminal 4.

The user terminal 4 displays a model-record-based-comparison analysis result screen for comparing the working activity to be analyzed with a model working activity. The model-record-based-comparison analysis result screen is displayed when a user operates the thumbnail indicator 57 in the single subject mode analysis result screen (see FIG. 10) to select one of the thumbnail images of the model working activities.

The model-record-based-comparison analysis result screen includes the time series graph indicator 51, the working worker's video indicator 52, the joint designation interface 53, the “model record comparison” button 55, the “past record comparison” button 56, and the thumbnail indicator 57, which parts indicate information associated with the working activity to be analyzed, and which are also included in the single subject mode analysis result screen (see FIG. 10)

This model-record-based-comparison analysis result screen includes a time series graph indicator 61 for indicating time series graphs for the working activity to be compared, and a working worker's video indicator 62 for indicating a corresponding video. The time series graph indicator 61 indicates time series graphs of two joint positions associated with a model working activity to be compared. The working worker's video indicator 62 indicates a working worker's video associated with the model working activity to be compared.

In the present embodiment, since the screen displays time series graphs for a working activity to be analyzed and time series graphs associated with a model working activity such that the corresponding time series graphs are arranged in vertical alignment with each other, a user can visually compare the graphs to thereby recognize differences between the working activity to be analyzed and the model working activity indicated in the graphs. Furthermore, since the screen displays a working worker's video of a working activity to be analyzed and a working worker's video of a model working activity such that the two videos are displayed in vertical alignment with each other, a user can visually compare the two videos to thereby recognize differences between the working activity to be analyzed and the model working activity shown in the videos.

The time series graph indicator 51 displays rectangular labels 65 overlaid on time series graphs for the working activity to be analyzed, each rectangular label representing a target range of the working activity to be analyzed. The target range of the working activity to be analyzed is a period during which a co-occurrence score is low, more specifically, equal to or less than a predetermined threshold value.

The time series graph indicator 61 displays rectangular labels 66 overlaid on time series graphs for the working activity to be compared, each rectangular label representing a target range of the working activity to be compared, as in the case of the working activity to be analyzed. The target range of the working activity to be compared is a period formed by adding predetermined additional periods to both prior to and subsequent to the target range of the working activity to be analyzed, respectively. Since the progress of the working activity varies depending on the worker, the target range of the working activity to be compared is determined by extending the target range to be analyzed in both the early and late directions. As a result, the screen can indicate to a user a period during which the same task is performed in each of the both working activities.

In the present embodiment, rectangular labels 65 and 66 are used as mark images representing target ranges. However, the marks representing the target ranges are not limited to the rectangular labels 65 and 66. For example, a mark image representing a target range may be a symbol such as “!” or any other symbol. In other embodiments, each of the time series graph indicators 51 and 61 may indicate only the part of a time series graph which corresponds to a target range.

In the embodiment shown in FIG. 11, one target range is included in a time series graph. However, when two or more periods with low co-occurrence scores appear intermittently, a plurality of target ranges may be indicated based on the number of target ranges set by using the setting screen of FIG. 9.

As described above, in the present embodiment, a target range; that is, a period in which work efficiency is low is highlighted, which enables a user to quickly recognize a working activity which is highly required to be improved.

This model-record-based-comparison analysis result screen includes a “model record comparison” button 55 and a “past record comparison” button 56, which are included in the single subject mode analysis result screen (see FIG. 10). When a user operates the “past record comparison” button 56 and selects one of the thumbnail images, the screen transitions to the past-record-based-comparison analysis result screen (see FIG. 12).

Next, a past-record-based-comparison analysis result screen displayed on the user terminal 4 will be described. FIG. 12 is an explanatory diagram showing the past-record-based-comparison analysis result screen displayed on the user terminal 4.

The user terminal 4 displays a past-record-based-comparison analysis result screen for comparing a working activity to be analyzed with past working activities for the same task performed by the same person as the working activity to be compared. The past-record-based-comparison analysis result screen is displayed when a user operates the “past record comparison” button 56 in the model-record-based-comparison analysis result screen (see FIG. 11).

The past-record-based-comparison analysis result screen includes the time series graph indicator 51 for indicating time series graphs for the working activity to be analyzed and the working worker's video indicator 52 for indicating a corresponding video, and a time series graph indicator 61 for indicating time series graphs for the working activity to be compared, and a working worker's video indicator 62 for indicating a corresponding video, as well as the joint designation interface 53, the “model record comparison” button 55, the “past record comparison” button 56, and the thumbnail indicator 57, which are also included in the model-record-based-comparison analysis result screen (see FIG. 11).

The time series graph indicator 61 for indicating time series graphs for the working activity to be compared, indicates time series graphs of two joint positions associated with a past working activity to be compared. The working worker's video indicator 62 indicates a working worker's video associated with the past working activity to be compared.

In the present embodiment, since the screen displays time series graphs for a working activity to be analyzed and time series graphs associated with a past working activity performed by the same person such that corresponding graphs are in vertical alignment with each other, a user can visually compare the graphs to thereby recognize differences between the working activity to be analyzed and the past working activity shown in the graphs. Furthermore, since the screen displays a working worker's video of a working activity to be analyzed and a working worker's video of a past working activity such that the two videos are displayed in vertical alignment with each other, a user can visually compare the two videos to thereby recognize differences between the working activity to be analyzed and the past working activity both shown in the videos.

The time series graph indicator 51 for indicating graphs of the working activity to be analyzed indicates the rectangular labels 66 representing a target range of the working activity to be analyzed, while the time series graph indicator 61 for indicating graphs of the working activity to be compared indicates the rectangular labels 66 representing a target range of the working activity to be compared, as in the model-record-based-comparison analysis result screen (see FIG. 11).

This past-record-based-comparison analysis result screen includes the “model record comparison” button 55 and the “past record comparison” button 56. When a user operates the “model record comparison” button 55, the screen transitions to the model-record-based-comparison analysis result screen (see FIG. 11).

In the screens shown in FIGS. 10, 11 and 12, the time series graph indicators 51, 61 indicate time series graphs of joint positions. However, when a user selects the joint speed in the motion information designation interface 42 of the setting screen (see FIG. 9), the time series graph indicators 51, 61 indicate time series graphs of joint movement speeds (see FIGS. 3 (B-1) and (B-2)).

Specific embodiments of the present disclosure are described herein for illustrative purposes. However, the present disclosure is not limited to those specific embodiments, and various changes, substitutions, additions, and omissions may be made for features of the embodiments without departing from the scope of the invention. In addition, elements and features of the different embodiments may be combined with each other to yield an embodiment which is within the scope of the present disclosure.

### INDUSTRIAL APPLICABILITY

A work analyzing device and a work analyzing method according to the present disclosure achieve an effect of enabling easy analysis and evaluation of work efficiency of a worker without burdensome tasks and easy determination of a worker's skill level by comparing the worker's work efficiency with that of another worker or a past record of the same worker, and are useful as a work analyzing device and a work analyzing method in which a processor is caused to perform operations to output analytical information on a work efficiency status of a worker based on a video of working activities of the worker.

### GLOSSARY

1 camera
2 recorder
3 server (work analyzing device)
4 user terminal
11 video input device
12 screen output device
13 memory
14 processor
41 joint designation interface
42 motion information designation interface
43 target range designation interface
51, 61 time series graph indicator
52, 62 working worker's video indicator
53 joint designation interface
57 thumbnail indicator
65, 66 rectangular label (image representing target range)

1. A work analyzing device in which a processor is caused to perform operations to output analytical information on a work efficiency status of a worker based on a video of working activities of the worker,
wherein the processor is configured to:
perform a joint position estimation based on the video to estimate joint positions of the worker;
acquire time series data on multiple joint positions based on results of the joint position estimation;
perform a work efficiency determination based on the time series data to determine work efficiency; and
generate, based on results of the work efficiency determination, the analytical information including information on a target range which is a part of a work process and the video.

2. The work analyzing device according to claim 1, wherein the processor is configured to:
output information on a section in which the work efficiency is determined to be low, as the information on the target range.

3. The work analyzing device according to claim 1, wherein the processor is configured to:
output an image representing the target range as the analytical information, the image being overlaid on a time series graph that visualizes the time series data.

4. The work analyzing device according to claim 1, wherein the processor is configured to:
output a posture image indicating a posture of the worker generated based on the joint positions as the analytical information, the posture image being overlaid on the video.

5. The work analyzing device according to claim 1, wherein the processor is configured to:
as a model working activity to be compared to a target working activity that is subject to analysis, choose a working activity with high work efficiency; and
output the analytical information on the target working activity and the analytical information on the model working activity.

6. The work analyzing device according to claim 5, wherein the processor is configured to:
output thumbnail images for videos of corresponding a plurality of model working activities; and
when a user selects one of the thumbnail images, output the analytical information on the model working activity corresponding to the selected thumbnail image.

7. The work analyzing device according to claim 1, wherein the processor is configured to:
as a model working activity to be compared to a target working activity that is subject to analysis, choose a past working activity that a person performing the target working activity has performed before; and
output the analytical information on the target working activity and the analytical information on the past working activity.

8. The work analyzing device according to claim 7, wherein the processor is configured to:
output thumbnail images for videos of corresponding a plurality of past working activities; and
when a user selects one of the thumbnail images, output the analytical information on the past working activity corresponding to the selected thumbnail image

9. The work analyzing device according to claim 1, wherein the processor is configured to:
output a search screen on which a user can enter one or more search criteria; and
output the analytical information on a working activity which meets the entered search criteria.

10. The work analyzing device according to claim 1, wherein the processor is configured to:
output a settings screen on which a user can designate a target joint of a human body; and
output the analytical information on the target joint designated by the user through the settings screen.

11. A work analyzing method for causing a processor to perform operations to output analytical information on a work efficiency status of a worker based on a video of working activities of the worker, the operations comprising:
performing a joint position estimation based on the video to estimate joint positions of the worker;
acquiring time series data on multiple joint positions based on results of the joint position estimation;
performing a work efficiency determination based on the time series data to determine work efficiency; and
generating, based on results of the work efficiency determination, the analytical information including information on a target range which is a part of a work process and the video.
